(19) United States
(12) Patent Application Publication
(10) Pub. No.: US 2003/0068999 A1
(43) Pub. Date: Apr. 10, 2003

(54) Interactive taxi information system

(76) Inventors: Joseph A. Casali, Kinnelon, NJ (US); James Piccione, New York, NY (US); Marco Pici, West Harrison, NY (US); Jan Scott Goodman, New York, NY (US)

Correspondence Address: KATTEN MUCHIN ZAVIS ROSENMAN, 575 MADISON AVENUE, NEW YORK, NY, 10022-2585, US

(21) Appl. No.: 10/190,646

(22) Filed: Jul. 8, 2002

Related U.S. Application Data
(60) Provisional application No. 60/327,971, filed on Oct. 9, 2001.

(51) Int. Cl. H04B 1/06

(52) U.S. Cl. 455/345; 455/566; 455/517

(57) ABSTRACT

A wireless vehicle passenger information system, storing information downloaded from a wireless server that can be retrieved by a vehicle passenger according to hierarchically ordered information categories. A touch screen display securely fixed within a passenger compartment provides a passenger interface to the system. The system optionally includes a global positioning system sender unit and driver and passenger compartment digital cameras, each interconnected to the information system for uploading position and image information to the wireless server for auxiliary monitoring.

### CROSS-REFERENCE TO RELATED APPLICATION

The present application claims priority under 35 U.S.C. §119(e) from U.S. Serial No. 60/327,971, filed on Oct. 9, 2001. U.S. Serial No. 60/327,971 was filed by at least one inventor common to the present application, and is hereby incorporated by reference.

### FIELD OF THE INVENTION

This invention relates to a wireless communication system for vehicles. More particularly, the invention relates to a wireless interactive communication and advertisement display system for taxis and other “for-hire” public transportation passenger vehicles.

### BACKGROUND OF THE INVENTION

Passengers using taxis and other “for-hire” public transportation passenger vehicles often need information relating to the city or region in which they are traveling. This is especially true, for example, in cases where passengers are non-residents unfamiliar with the city or region in which they are traveling. Even in cases where passengers are residents and/or are familiar with the city or region in which they are traveling, they may none-the-less have a need for specialized city and regional information (for example, entertainment, dining, upcoming civic events, road closings and the like).

Studies suggest that the average length of a taxi ride in major cities like New York City is about 13 minutes. During this time, passengers can easily review city and regional information, interact with advertisements, check out the latest news stories or browse through restaurant, nightlife and other information relating to their travel. Accordingly, it would be advantageous to provide a system for use in taxis and other for-hire vehicles to selectively and visually provide passengers with the city, regional and other information they may be seeking. It would also be advantageous if such information could be updated as necessary in real time, and could be easily accessed, for example, by touching interactive buttons located on a touch screen monitor.

There are examples known in the art of systems that provide local information (for example, touch screen building directories, stationary information kiosks and the like). An on-board TV for displaying advertising in taxis has been marketed by TaxiVision of Las Vegas, Nev. However, this system does not provide a mechanism for real-time updating of information to be provided to passengers or real-time access to networked information (for example, as is available over the Internet). Wireless vehicle communications systems such as the ONSTAR system produced by General Motors Corporation provide for real-time transfer of information to and from vehicles, but have not provided such information to passengers in a visual and hierarchically organized form.

### SUMMARY OF THE INVENTION

These and other deficiencies have been solved by a novel information system for use in a taxi or other similar vehicle. The vehicle information system includes a processor, a memory, display, a passenger interface and a wireless communication interface. The display and passenger interface may preferably be embodied in a touch-screen monitor.

Passenger information is received at the wireless communication interface and stored by the processor in the memory. The passenger interface may be manipulated to selectively retrieve portions of the passenger information from the memory for viewing, for example, on the touch-screen monitor.

In a first embodiment of the present invention, a portion of the passenger information is automatically viewed on the touch screen monitor without any passenger intervention in a cycle comprising one or more segments, where the segments are viewed in either a predetermined or a random order. Segments may provide, for example, advertisements, other passenger-oriented information, and/or a combination thereof.

The system may also comprise a navigational receiver coupled to the processor and the memory for receiving navigational and location information and storing the navigational and location information in the memory.

A wireless communication interface provides for communications between the information system and a base station over a wireless Local Area Network (LAN), or alternatively over a wireless broadband connection, so that the base station may update passenger-directed information stored by the processor in the memory. Passengers may view this updated information, for example, by selecting one or more “soft key” buttons on the interactive touch-screen monitor.

The wireless-communication interface may also comprise a wireless modem for Internet and wireless telephony communications.

The system may optionally comprise an emergency signaling device for stimulating the processor to retrieve a predetermined information set from the memory and transmit this information over the wireless communications interface to an emergency service.

The system may optionally further comprise an imaging system (typically one or more video or digital still cameras) coupled to the processor and the memory for imaging passenger and driver compartments and storing representations of the images in the memory.

In a second embodiment of the present invention, the base station is operative to retrieve vehicle location status information and updating procedures via a wireless access point for one or more vehicle information systems, and display the information at the base station.

The system may further comprise secondary means for receiving inputs from passengers. For example, the system may include an infrared or other wireless interface for receiving information from and transmitting information to a passenger's personal digital assistant (PDA). Alternatively, the secondary means may include a card leading device for use of credit cards and for smart cards. Additionally, the base station may be configured to interact directly with media in the possession of passengers (for example, cellular phones and wireless PDAs).

### BRIEF DESCRIPTION OF THE DRAWINGS

A more complete understanding of the invention may be obtained by reading the following description of specific illustrative embodiments of the invention in conjunction with the appended drawing in which:

FIG. 1 illustrates an embodiment of the present invention in which a passenger display and interface of the present inventive system are positioned in the passenger compartment of a taxi;

FIG. 2(a) provides a diagram illustrating the principal components of the present invention and their interrelation;

FIG. 2(b) provides a diagram illustrating in-vehicle components of the present invention in additional detail;

FIGS. 3(a)-3(f) show several monitor screen images illustrating how passenger information is retrieved using a passenger touch screen monitor and interface of the present invention; and

FIG. 4 provides a flowchart illustrating how passenger information can be updated using an updating function of the present invention.

### DETAILED DESCRIPTION OF THE PREFERRED EMBODIMENTS

The following detailed description includes the best mode or modes of the invention presently contemplated. Such description is not intended to be understood in a limiting sense, but to be an example of the invention presented solely for illustration thereof, and by reference to which in connection with the following description and the accompanying drawings one skilled in the art may be advised of the advantages and construction of the invention.

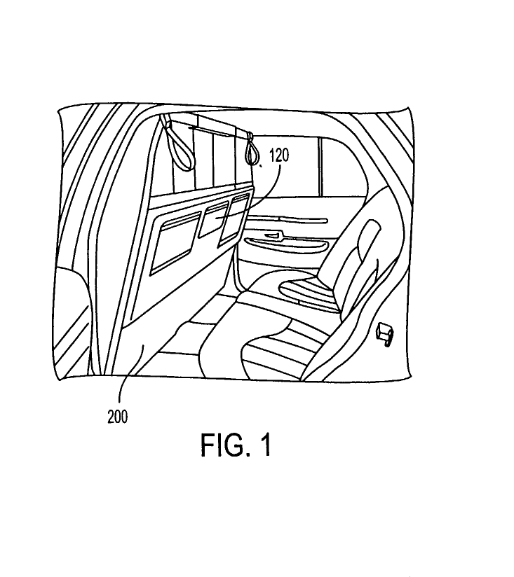

The present invention concerns an interactive, visual information system for primary use by passengers in a taxi or other for-hire vehicle. In a preferred embodiment, the system includes an on-board computer and an interactive touch-screen monitor, where the computer has a “ruggedized,” environmentally-hardened design (for example, a PENTIUM III based portable computer as manufactured by Amrel Systems Inc., running a MICROSOFT WINDOWS operating system) and a touch screen monitor (for example, a 12.1 inch acoustic wave touch screen with high impact surface as produced, for example, by ELO Touch Screens). The touch screen monitor is mounted in a “strong box” (as produced, for example, by REO Mobil Systems) securely mounted in the passenger vehicle, having availability to passengers in the passenger compartment. By way of example, FIG. 1 shows a touch screen monitor 120 consistent with the principles of the present invention mounted in the passenger compartment 200 of a taxi cab.

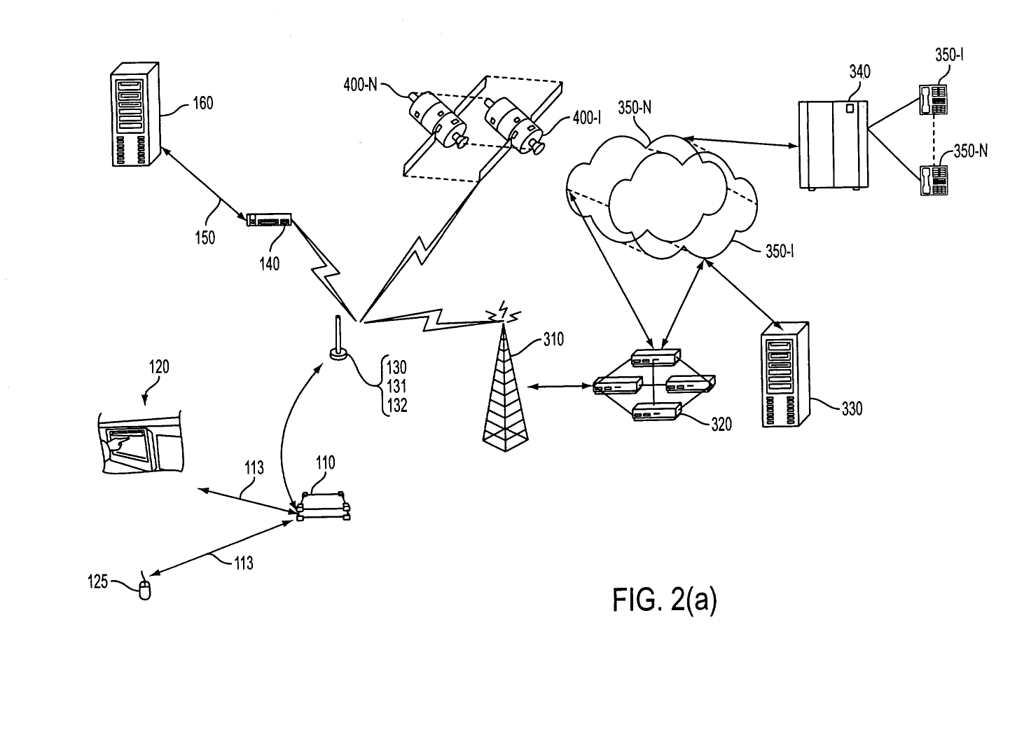

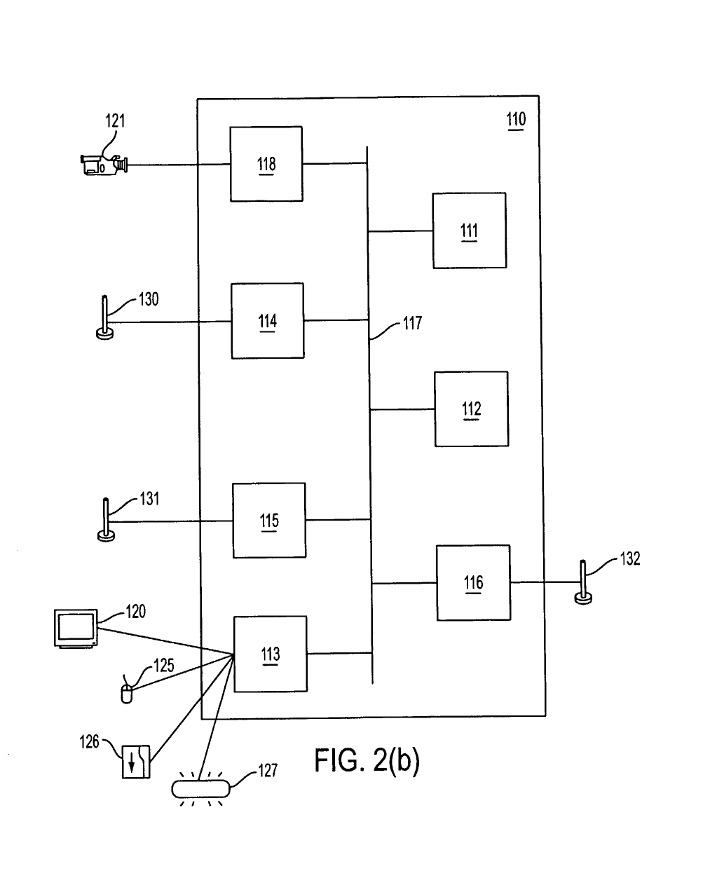

FIGS. 2(a) and 2(b) show block diagrams illustrating components of vehicle information system 100. Onboard computer 110 is placed in a secured position within a passenger vehicle (not shown), and interconnected in a conventional manner via input/output device 113 to passenger display and interface unit 120 and emergency assistance switch 125. Emergency assistance switch 125 may be configured for operation by either one or both of a passenger and a driver.

As shown in FIG. 2b, input/output device 113 may further interconnect at least one of a card reader 126 and a wireless communications port 127 to computer 110 for transmitting to and receiving information from media in a passenger's possession. Card reader 126 may be used, for example, to obtain information from a credit card and/or to exchange information with a debit card or smart card. This may prove useful for passenger authentication and various e-commerce functions (for example, use of a “digital wallet” in response to a purchase offer displayed on monitor 120). Wireless port 127 may be used for exchanging information between computer 110 and an intelligent device in the possession of a passenger (for example, a personal digital assistant, a handheld computer, a cellular telephone or the like). Wireless port 127 may employ one of a variety of conventional infrared communications or other wireless communications protocols (for example, Bluetooth). Information retrieved from the passenger and stored by the computer 110 in memory 112 may identify the passenger by a personal ID (such as a credit card number), or alternatively, by an anonymous ID (similar to that associated with Internet “cookies”), or not at all. As will be further described herein, base station server 160 of FIG. 2(a) may be further operative to collect, store and aggregate such passenger information.

Computer 110 further is further interconnected to one or more of antennas 130, 131, 132 through a variety of interfaces in order to facilitate several modes of wireless and radio communications, which will be further described herein.

For example, and as further shown in FIG. 2(b), computer 110 includes conventional wireless Local Area Network (LAN) interface 114 that communicates via antenna 130 and wireless access point 140 through private network 150 with base station server 160. As shown in FIG. 2(b), this communication path may be used to download passenger information via wireless LAN interface 114, bus 117 and processor 111 to memory 112 of computer 110.

Computer 110 of FIG. 2(b) may be further equipped with conventional radio modem 115 for supporting communications via public/private networks 350 of FIG. 2(a). Radio modem 115 of FIG. 2(b) communicates via antenna 131 to a conventional wireless service center including radio tower 310 and wireless switch network 320 of FIG. 2(a). Wireless switch network 320 is capable of accessing one or more or public/private networks 350 in order, for example, to provide Internet access via Internet Service Provider (ISP) server 330 (e.g., via network 350-1) or to provide telephonic access to a telephone terminal 350-1 via local telephone switch 340 (e.g., via network 350-n). Internet access may be employed, for example, to obtain near-real time passenger information associated with sports, news, weather, stock quotes and point-of-sale services. For such Internet applications, wireless modem 115 of FIG. 2(a) preferably supports a robust data communications oriented protocol such as the Cellular Digital Packet Data (CDPD) protocol. A variety of conventional access protocols may be supported by wireless modem 115 to provide telephonic access (for example, the Code Division Multiple Access (CDMA) protocol). Telephonic access may be employed, for example, by passengers to make restaurant reservations or to access emergency services.

Computer 110 of FIG. 2(b) may further include navigational receiver 116 which may be used in conjunction with antenna 131 to acquire navigational and location information relating to the vehicle containing computer 110. Navigational receiver 116 may preferably be a Global Positioning System (GPS) module (as produced, for example, by RoyalTek Company Ltd. of Tao Yuan City, Taiwan) to receive positional latitude and longitude from signals received at antenna 132 from GPS satellites 400 of FIG. 2(a). Navigational receiver 116 of FIG. 2(a) may be instructed by processor 111 to periodically obtain and report location information, which may be time stamped and stored in memory 112 for archival and future analysis. These navigation functions may be used, for example, to assist fleet management companies and law enforcement officials in locating distressed or stolen taxis. This information may also be used in conjunction with the touch screen to enable passengers to identify restaurants, theaters and other attractions in the current vicinity of the vehicle.

Computer 110 of FIG. 2(b) may optionally include a video or image interface 118 interconnecting one of more cameras 121 positioned in the vehicle to monitor each of the driver and passenger compartments (suitable cameras are produced commercially, for example, by X10). Interface 118 may be instructed by processor 111 to periodically obtain image information from cameras 121, which may be time stamped and stored in memory 112 for archival and future analysis.

Computer 110 is directly powered by a vehicle battery (not shown), and automatically powered on when the vehicle is started, using conventional notebook PC battery management means. The vehicle's battery provides a signal at a DC power port in the computer 110. The BIOS subsystem of the computer 110 is arranged so that, when the vehicle battery is activated, it automatically sends a “start signal” to the computer. Upon start-up, the computer automatically uploads associated software applications from disk memory in order to be ready for operation without any direct assistance from the driver.

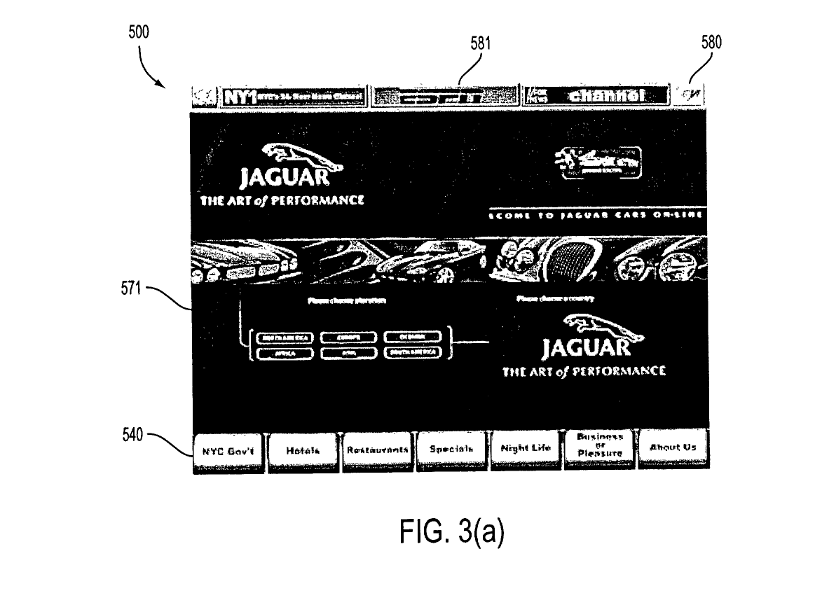

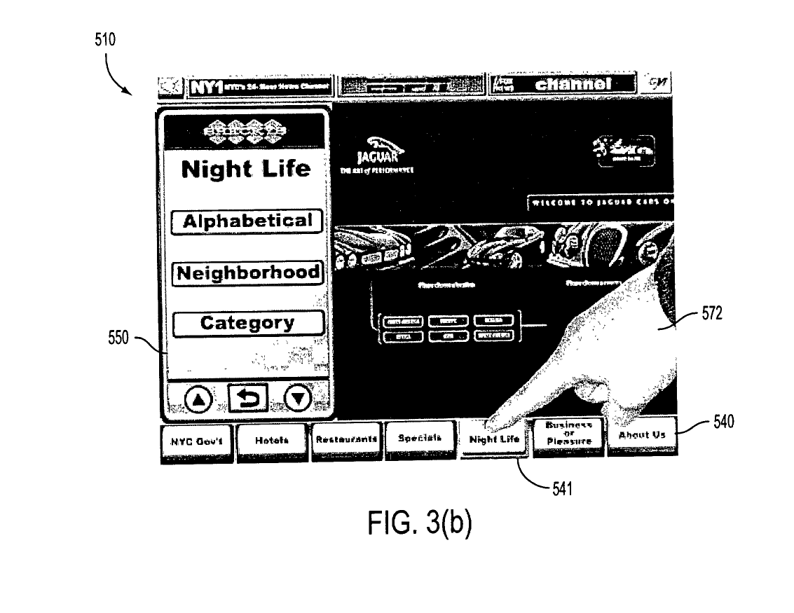

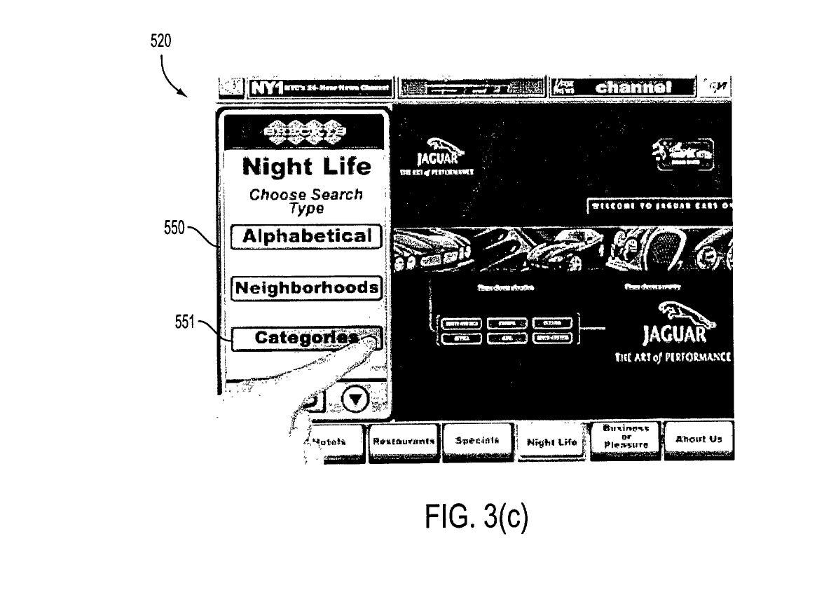

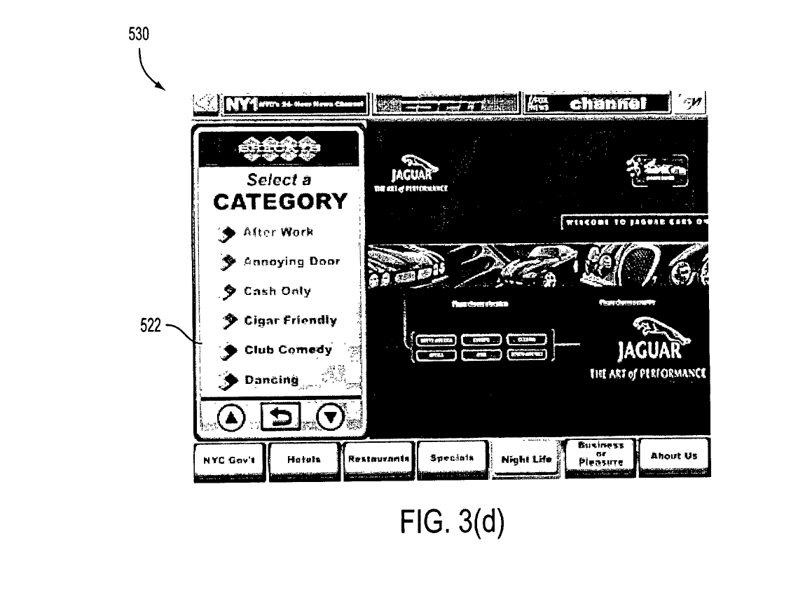

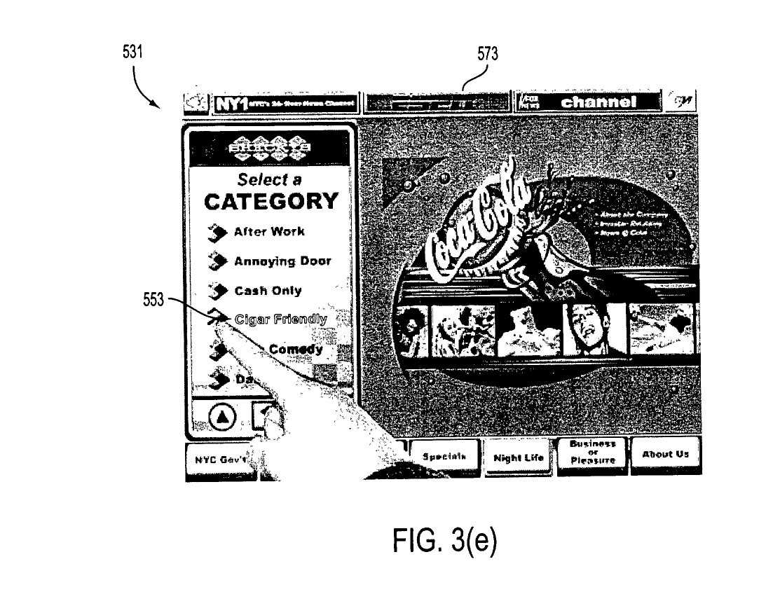

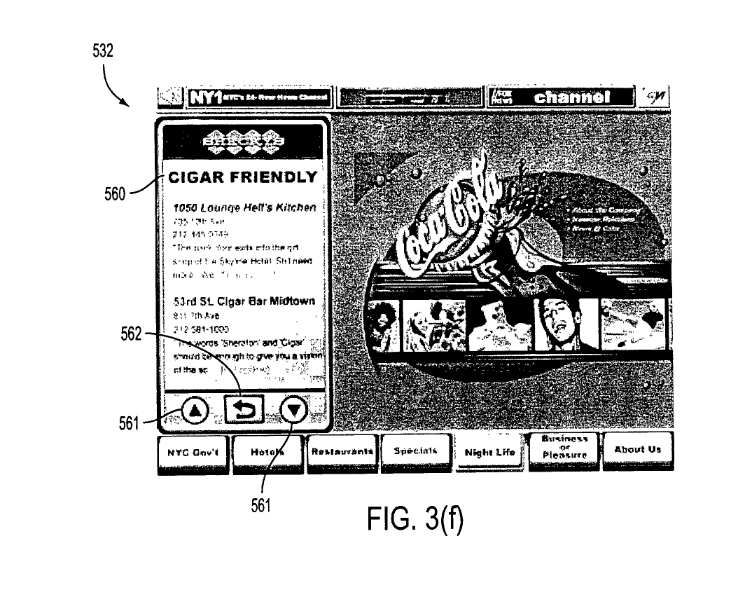

Vehicle information system 100 is configured to selectively provide vehicle passengers with information that is stored in memory 112. FIGS. 3(a)-3(f) illustrate a series or sequence of passenger screens 500 designed for this purpose. Passenger screen 500 may be organized, for example, to include a main menu bar 540 horizontally positioned at the bottom of screen 500 FIG. 3(a), and display frame 571 positioned above menu bar 540. Horizontally positioned at the top of screen 500 is services menu bar 580.

Main menu bar 540 may be used by passengers to select an information category of interest. By way of example, as shown in a sample screen 510 of FIG. 3(b), a passenger may touch main menu bar 540 on screen 510 in the vicinity of category button 541 entitled “Night Life.” In response, as shown in sample screen 520 of FIG. 3(c), menu 550 appears at a left edge of screen 520. A passenger may then touch menu 550 on screen 520 in the vicinity of a category button 551 entitled “Categories.” In response, as shown in sample screen 530 of FIG. 3(d), category screen 552 replaces menu 550 at the left edge of screen 530.

The passenger may then select, for example, category button 553 entitled “Cigar Friendly,” as shown on sample screen 531 of FIG. 3(e), and information frame 560 replaces category screen 552 at the left edge of screen 532 of FIG. 3(f). Information frame 560 may be configured to selectively frame a portion of the desired information, for example, through the use of scrolling buttons 561. Alternatively, a passenger may use linking button 562 to jump to a related portion of the information that may be indicated, for example, by a highlighted banner (not shown) on information frame 560.

Display screen 571 of FIG. 3(a) is configured to display advertisements and public service announcements, stored in memory 113 of FIG. 2(b), in either a sequenced or random order as directed by processor 110 of FIG. 2(b). When a menu bar selection is made, the content of display screen 571 is resized (for example, as shown by display screen 572 of FIG. 3(b)) to accommodate sub-category menu 550. Optionally, the advertisements and public service announcements shown in display screens 571, 572 may be organized with interactive menu bars for selective information display. Category and sub-category buttons associated with these advertisements and public service announcements may be selected in the same manner as described above.

When no selections are made during an idle period (for example, of about 30 seconds), the display screen 572 automatically returns to its full size as illustrated by display screen 571 of FIG. 3(a). A variety of public service announcements and advertisements may be changeably displayed, for example, in 10 second time slots (as illustrated by the sequence of display screens 571, 572 of FIG. 3(b) and 573 of FIG. 3(e)). A complete cycle may be set to equal the average length of a taxi ride (about 13 minutes in a major metropolitan city such as New York City). Under this scheme, there are approximately 78 slots within a cycle. A selected percentage (for example, 10 percent) may be allocated to public service announcements, while the remainder may be allocated to advertisements.

Cycles may be selected to run for an appropriate period of time (for example, continuously for 30 days). At the end of this period, the advertisements and public service announcements may be updated or replaced in the memory 112 of FIG. 2(a) by the base station 160 of FIG. 2(b) over the wireless LAN interface 114 of the computer 110 of FIG. 2(a). In this manner, updates may be efficiently applied, for example, to fleets of vehicles each equipped with the required vehicle information system 100 components.

Updates may be facilitated as follows. As suggested in FIGS. 2(a) and 2(b), wireless LAN 114 communicates with access point 140 to reach private network 150 in order to communicate with base station server 160. Private network 150 may be implemented, for example, using dedicated T1 facilities.

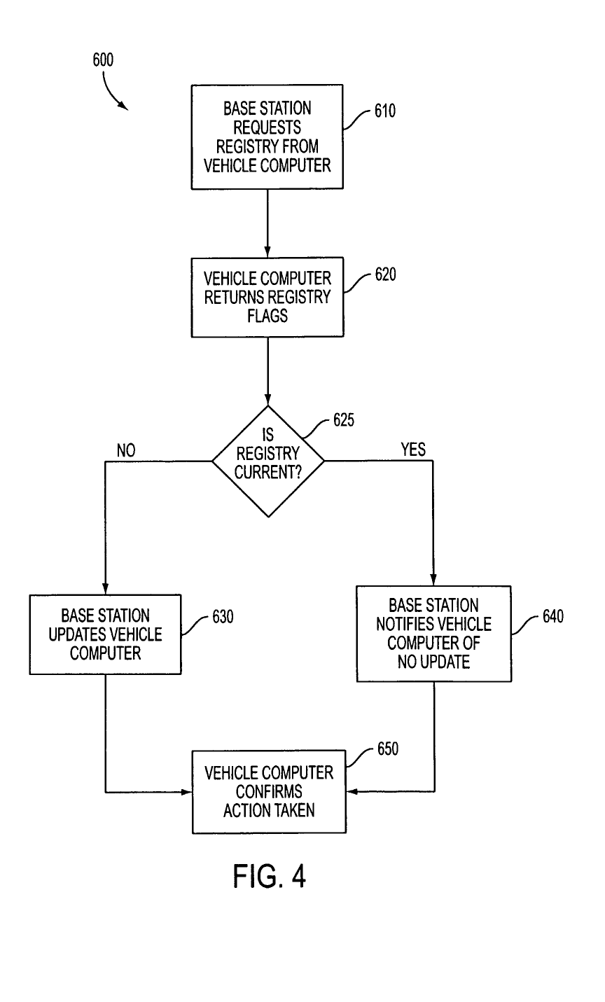

Once computer 110 and server 160 are in communication, an update protocol may be initiated. FIG. 4 diagrams update protocol 600. Base station server 160 begins the process by querying a registry in memory 112 of vehicle computer 110 to determine the value of an update flag (at steps 610, 620 of FIG. 4). The flag, for example, may consist of a timestamp indicating the age of the current passenger information stored in memory 112.

At step 625, based on the value of the update flag, base station server 160 decides either that an update is required (step 630) or that an update is not required (step 640). If an update is required, at step 630, base station server 160 proceeds with the update. Alternatively, at 640, base station server 160 notifies vehicle computer 110 that no update will be undertaken. At step 650, in response to either of steps 630 or 640, vehicle computer 110 returns a confirmation message to base station server 160. The message confirms one of three states: a) an update was initiated and completed, b) an update was initiated and not completed or c) an update was not initiated.

Passengers may desire access to additional information services. Returning to FIG. 3(a), services menu bar 580 may be selected by a vehicle passenger to retrieve additional information to be displayed on display screen 571. By selecting menu button 581, for example, processor 111 of FIG. 2(b) would instruct wireless modem 115 to initiate an Internet connection to retrieve a web page from an ESPN website for display in the display screen 571. Such selective passenger access to the Internet provides an effective means for accessing frequently changing information.

In response to a passenger's selection of button 581, processor 111 retrieves associated Internet address information from memory 112, and causes wireless modem 115 to transmit this address information to wireless switch 320 of FIG. 2(a) via radio tower 310. Wireless switch 320 identifies an associated Internet Service Provider (ISP) from the address information and/or subscriber information stored by wireless switch 320, and transfers the address information via switching network 350-1 to server 330, which is operated by the selected ISP. Server 330 interprets the address information to select and return a requested web page to information system 100.

Base station server 160 may perform additional functions by accessing information stored in memory 112 of vehicle computer 110. For example, server 160 may periodically retrieve vehicle status, location and time stamp information from onboard computers 110 in order to build fleet resource maps. As earlier noted, this information may be routinely stored in memories 112 of computers 110 of FIG. 2(b)for periodic retrieval by server 160 of FIG. 2(a). Such fleet maps could be used in directing adjustments to fleet deployment, and targeting portions of the fleet for traffic announcements based on certain traffic patterns.

In response to use of emergency assistance switch 125 of FIG. 2(a) by a passenger or driver, server 160 may operate to retrieve vehicle location and image information for forwarding to emergency personnel. This information may then, for example, be forwarded to a third party emergency service for dispatched response and/or voice response via an onboard communications system (similar to ONSTAR).

With reference to FIGS. 2(a), (b), passenger information may also be stored locally in the computer 110, and then later retrieved via the wireless connection by server 160. For example, computer 110 may display on touch screen monitor 120 a consumer preferences survey inviting response from a passenger. Upon responding, passenger responses may be stored by memory 112 for subsequent retrieval and processing by server 160.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention.

What is claimed is:

1. An information system for passengers in a vehicle, the system comprising:
a processor;
a memory;
a display;
a passenger interface; and
a wireless communication interface;
wherein passenger information is received at the wireless communication interface and is stored by the processor in the memory, and wherein stored passenger information is selectively retrieved by the processor from the memory and displayed by the display in response to one or more commands received at the passenger interface.

2. The vehicle information system of claim 1, wherein passenger information is selected from the group consisting of news information, restaurant and lodging information, community event information, entertainment information, map and telephone information, Internet address information, advertisements and public service announcements.

3. The vehicle information system of claim 1, wherein the passenger information is stored in the memory in one or more graphically formatted data files selected from the group consisting of JPEG files, MPEG files, web animation files and flash files.

4. The vehicle information system of claim 1, wherein the processor, memory and wireless communication interface are each located in a hardened enclosure.

5. The vehicle information system of claim 1, wherein the display and the passenger interface comprise a touch-screen monitor for fixedly mounting to a surface within a passenger compartment.

6. The vehicle information system of claim 5, wherein the passenger interface further comprises a card reading device capable of reading at least one of a credit card, a debit card and a smart card.

7. The vehicle information system of claim 5, wherein the passenger interface further comprises a wireless data port for interacting with an intelligent device.

8. The vehicle information system of claim 7, wherein the wireless data port operates using an infrared spectrum.

9. The vehicle information system of claim 7, wherein the wireless data port operates to receive information from the intelligent device, the information comprising e-commerce information including at least one of credit card information, debit card information and electronic payment information.

10. The vehicle information system of claim 9, wherein the received information is stored by the processor in the memory.

11. The vehicle information system of claim 7, wherein the wireless data port operates to transmit at least one of passenger information and received information to the intelligent device.

12. The vehicle information system of claim 5, wherein the passenger interface further comprises a physical data port for interacting with a computing device.

13. The vehicle information system of claim 1, wherein a portion of the passenger information is automatically retrieved from the memory and displayed on the display by the processor in accordance with program instructions stored in the memory.

14. The vehicle information system of claim 13, wherein the portion of the passenger information is automatically displayed as one or more segments, the one or more segments being displayed in predetermined sequence during a cycle.

15. The vehicle information system of claim 14, wherein the one or more segments are alternatively displayed in a random sequence during the cycle.

16. The vehicle information system of claim 14, wherein the cycle has a predetermined duration.

17. The vehicle information system of claim 14, wherein the cycle duration is equal to an average ride time for a passenger.

18. The vehicle information system of claim 1, wherein passenger information is selectively retrieved by selecting at the passenger interface one or more of a plurality of hierarchically ordered menu options displayed on the display.

19. The vehicle information system of claim 1, further comprising at least one imaging system coupled to the processor and the memory for imaging one or more of a passenger compartment and a driver compartment, so that the images may be stored by the processor in the memory.

20. The vehicle information system of claim 19, wherein a stored image is transmitted over the wireless communications interface.

21. The vehicle information system of claim 1, further comprising a navigational receiver coupled to the processor and the memory for receiving navigational data, so that the data may be stored by the processor in the memory.

22. The vehicle information system of claim 21, where the navigational receiver is a global positioning system (GPS) receiver.

23. The vehicle information system of claim 1, further comprising an emergency signaling device, the emergency signaling device operative to stimulate the processor to retrieve a predetermined information set stored in the memory and transmit the predetermined information set over the wireless communications interface.

24. The vehicle information system of claim 23, wherein the predetermined information set includes navigational information identifying a location for the vehicle information system.

25. The vehicle information system of claim 1, wherein the wireless communications interface provides for communications with a base station server over at least one of a wireless Local Area Network (LAN) and a wireless broadband network.

26. The vehicle information system of claim 1, wherein the wireless communications interface comprises a wireless data modem.

27. A vehicle information system, the system comprising:
a base station server having one or more wireless access points; and
a mobile information center having:
a processor;
a memory;
a display;
a passenger interface; and
a wireless communication interface;
wherein passenger information is transmitted by the base station server from one of the one or more wireless access points, and is received by the wireless communication interface of the mobile information center and stored by the processor in the memory.

28. The vehicle information system of claim 27, wherein the stored passenger information is selectively retrieved by the processor from the memory and displayed by the display in response to one or more commands received at the passenger interface.

29. The vehicle information system of claim 27, wherein the vehicle information system comprises a plurality of mobile information centers for receiving passenger information from the base station server.

30. The vehicle information system of claim 27, wherein the display and the passenger interface comprise as a touch-screen monitor for fixed mounting to a surface within a passenger compartment.

31. The vehicle information system of claim 27, wherein passenger information is selected from the group consisting of news information, restaurant and lodging information, community event information, entertainment information, map and telephone information, Internet address information, advertisements and public service announcements.

32. The vehicle information system of claim 29, wherein the base station further comprises a processor and a memory, and is operative to query and retrieve information from each of the plurality of mobile information centers over at least one of the one or more wireless access points, and to store the retrieved information in the base station memory.

33. The vehicle information system of claim 32, wherein each of plurality of mobile information centers has a navigational system for receiving navigational information, and the information retrieved by the base station is the received navigational information.

34. The vehicle information system of claim 32, wherein each of the plurality of mobile information systems periodically stores information about vehicle status in the memory, and the information retrieved by the base station is the vehicle status information.

35. The vehicle information system of claim 34, wherein the status information comprises time information.

36. The vehicle information system of claim 32, wherein the passenger interface further comprises at least one of a card reading device and a wireless data port for interacting with an intelligent device, and the information retrieved by the base station originates at the passenger interface.
